(19) United States
(12) Patent Application Publication
(10) Pub. No.: US 2025/0390422 A1
(43) Pub. Date: Dec. 25, 2025

(54) MULTIPLE NAMESPACE ERROR INJECTION TEST FRAMEWORKS

(71) Applicant: International Business Machines Corporation, Armonk, NY (US)

(72) Inventors: Xiaopeng ZHANG, Beijing (CN); Yi YUAN, Beijing (CN); Xiao Hu HE, Beijing (CN)

(21) Appl. No.: 18/750,416

(22) Filed: Jun. 21, 2024

(51) Int. Cl. G06F 11/36

(52) U.S. Cl. CPC G06F 11/3688; G06F 11/3698

(57) ABSTRACT

Method and apparatus for improved computing system test execution are provided. A test framework is accessed. A group namespace annotation is detected in the first test framework. A first set of test cases is executed in a first namespace corresponding to the group namespace annotation. A duplicated namespace annotation is detected in the first test framework. A second set of test cases is executed in a plurality of namespaces corresponding to the duplicated namespace annotation.

### BACKGROUND

The present disclosure relates to computing system error testing, and more specifically, to improved error injection test frameworks.

Computing systems have become increasingly complex, resulting in a similarly increase in the complexity of error testing. There is a need for flexible and efficient testing techniques capable of simulating errors, such as network failures, I/O exceptions, and hardware errors, within a controlled and reproducible environment. Ensuring the resilience and fault-tolerance of software applications, particularly those designed for complex and distributed systems, is important for the reliability and robustness of such applications.

Conventional frameworks for error testing generally operate within a single namespace in the computing system. When multiple test cases are designed under a common hardware error condition (e.g., network failure), these test cases are executed sequentially due to such namespace limitations.

### SUMMARY

According to one embodiment of the present disclosure, a method is provided. The method includes accessing a first test framework; detecting, in the first test framework, a group namespace annotation; executing a first set of test cases in a first namespace corresponding to the group namespace annotation; detecting, in the first test framework, a duplicated namespace annotation; and executing a second set of test cases in a plurality of namespaces corresponding to the duplicated namespace annotation.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; and a computer program product embodied on a computer-readable storage medium comprising code for performing the aforementioned methods as well as those further described herein.

The following description and the related drawings set forth in detail certain illustrative features of one or more embodiments.

### BRIEF DESCRIPTION OF THE DRAWINGS

FIG. 1 depicts an example computing environment for the execution of at least some of the computer code involved in performing the inventive methods.

FIG. 2 depicts a system for improved error injection in computing environments, according to some embodiments of the present disclosure.

FIG. 3 depicts an example workflow for error testing in computing environments, according to some embodiments of the present disclosure.

FIG. 4 is a flow diagram depicting an example method for multiple namespace error testing in computing environments, according to some embodiments of the present disclosure.

FIG. 5 is a flow diagram depicting an example method for improved error testing, according to some embodiments of the present disclosure.

### DETAILED DESCRIPTION

Embodiments of the present disclosure provide techniques for improved (e.g., more efficient) error analysis in computing environments.

In some embodiments of the present disclosure, testing frameworks that extend existing frameworks by harnessing namespaces (e.g., Linux namespaces) are provided. As used herein, a “namespace” refers to a partition of computing resources (e.g., such that processes in one namespace see one set of resources while processes in another namespace see another set of resources). Some resources may exist in multiple namespaces, while others may exist only in a particular namespace. Using such namespaces enables containerization of the processes, isolating each from others and facilitating efficient computation.

Embodiments of the present disclosure enable the creation of controlled testing environments across multiple namespaces, facilitating the injection and simulation of diverse error conditions. This approach ensures isolation within namespaces, streamlining the design and creation of test cases while minimizing the associated effort. Further, aspects of the present disclosure enable parallel testing of multiple test cases across multiple namespaces. As a result, test performance is significantly enhanced, leading to improved efficiency and effectiveness

In some embodiments, a test framework that enables the execution of test cases in a multi-namespace environment is provided. In some embodiments, a test framework flag or annotation is provided for executing test cases across multiple namespaces. In some embodiments, annotations can be utilized to group multiple test cases within a single namespace, and/or to multiplex a single test case into multiple namespaces, isolating error conditions and resource occupation in each namespace.

In some embodiments, a dedicated test framework designed specifically for running test cases in multiple namespaces is provided. This can enhance existing test frameworks to support the execution of test cases in multiple namespaces, incorporating features that enable seamless execution of test cases across various namespaces. In some aspects, annotations are utilized to group and multiplex test cases within and across namespaces, ensuring isolation of system resource errors and resource occupation for different test case groups within distinct namespaces.

As discussed below in more detail, in some embodiments, system resource error injection and resource occupation is isolated by leveraging namespaces, such as by executing different groups of test cases in separate namespaces to prevent interference and ensure isolation. This can guarantee that the execution of one group of test cases does not impact others, preserving the integrity of test results and ensuring that error conditions are contained within the designated namespaces.

In some embodiments, as discussed below in more detail, a "write-once, execute-many-times" approach for test cases involving error injection can be provided, where test cases can be written once and executed multiple times with varied error injections. This can optimize the testing process by enabling efficient reuse of test cases for different error scenarios, while ensuring that each execution occurs in a controlled environment within specific namespaces, preventing cross-contamination of results.

In some embodiments, the framework can aggregate multiple test-case methods into a single group, ensuring they run within the same namespace, while other groups of test-case methods execute in separate namespaces. Further, in some embodiments, the framework replicates a single test-case method across multiple namespaces as defined by annotations. Each namespace can be configured to simulate different error conditions during test execution.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

### Example Computing Environment

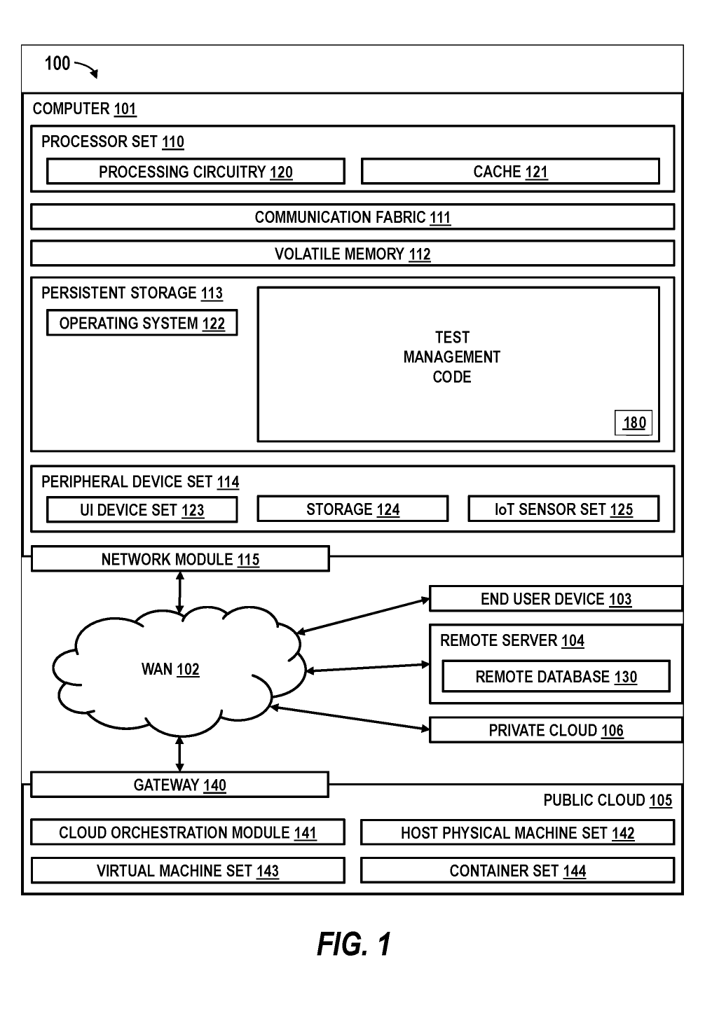

FIG. 1 depicts an example computing environment 100 for the execution of at least some of the computer code involved in performing the inventive methods.

Computing environment 100 contains an example of an environment for the execution of at least some of the computer code involved in performing the inventive methods, such as test management code 180. In addition to test management code 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and test management code 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in test management code 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in test management code 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Example System for Improved Error Injection in Computing Environments

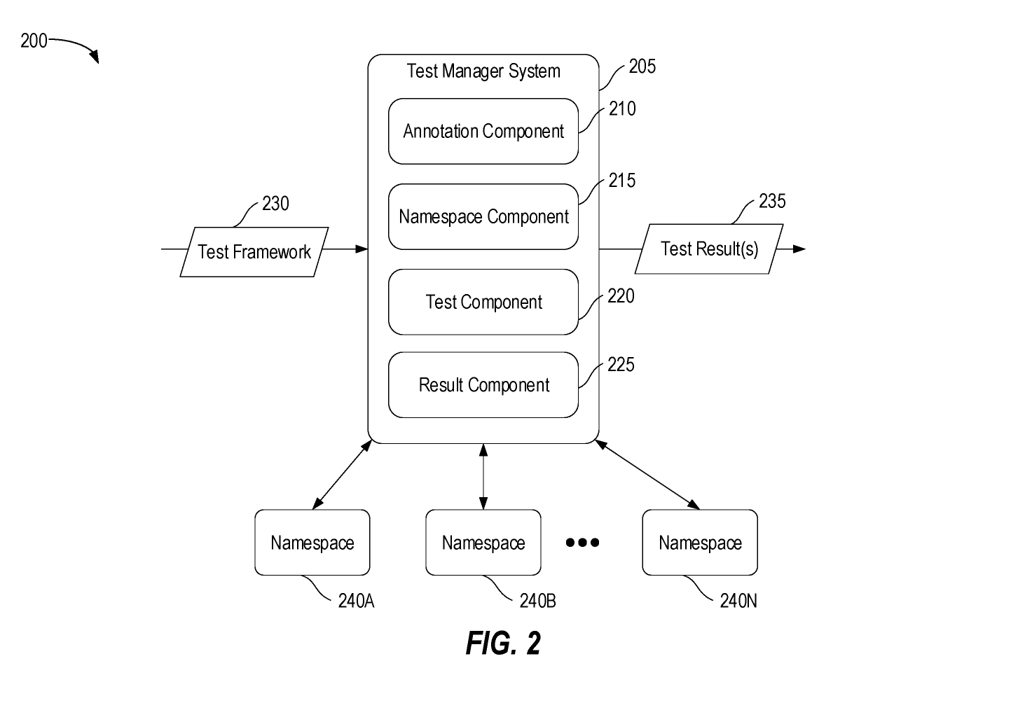

FIG. 2 depicts a system 200 for improved error injection in computing environments, according to some embodiments of the present disclosure. In some embodiments, some or all of the depicted components of the system 200 may correspond to the test management code 180 of FIG. 1.

In the illustrated example, a test manager system 205 receives or accesses test frameworks 230 and generates test results 235. As used herein, “accessing” data can generally include receiving, requesting, retrieving, obtaining, generating, or otherwise gaining access to the data. For example, the test manager system 205 may receive the test framework(s) 230 from a user, may retrieve them from memory, and the like. Although depicted as a single discrete system for conceptual clarity, in embodiments, the operations of the test manager system 205 may be combined or distributed across any number of systems, and may generally be implemented using hardware, software, or a combination of hardware and software.

The test framework 230 is generally a data structure specifying the testing to be carried out on one or more computing systems. For example, in some aspects, the test framework 230 includes natural language text and/or programming instructions in one or more programming languages, specifying the test(s) to be performed, the namespace(s) in which the test(s) should be performed, the error(s) to be injected for each test and/or namespace, and the like. In some aspects, as discussed below in more detail, the test framework 230 may optionally include an annotation, label, flag, or other indication that the test framework 230 includes or involves multiple namespace testing (referred to in some aspects as a multiple namespace annotation). For example, the presence of such an annotation may indicate that one or more tests are to be grouped and executed within a single namespace, and/or that one or more tests are to be duplicated and executed in multiple namespaces in parallel.

In the illustrated example, the test manager system 205 includes a variety of components including an annotation component 210, a namespace component 215, a test component 220, and a result component 225. Though depicted as discrete components for conceptual clarity, the operations of the depicted components (and others not illustrated) may be combined or distributed across any number of components.

In some embodiments, the annotation component 210 is used to evaluate input test frameworks 230 to identify relevant testing annotations, if any, in order to drive testing. For example, the annotation component 210 may identify a multiple namespace annotation indicating that the test framework 230 (potentially) includes tests to be executed as a group in a single namespace and/or test(s) to be executed in multiple namespaces. In some aspects, the annotation component 210 may also identify annotations indicating the particular testing strategies in more detail. For example, the annotation component 210 may identify annotations indicating or identifying one or more sets of tests that should be grouped and executed in a single namespace (referred to as “group namespace annotations” in some aspects). That is, the test framework 230 may include an annotation used to identify tests that should be executed as a group in a single namespace, regardless of how and where the tests themselves are defined in the test framework 230.

As another example, the annotation component 210 may identify annotations indicating or identifying one or more tests that should be duplicated or executed in multiple namespaces separately (potentially with different error injections). Such an annotation may be referred to as a “duplicated namespace annotation” in some embodiments. That is, the test framework 230 may include an annotation that identifies a single test as a duplicated test, indicating that the test should be executed in multiple namespaces (even if it is only defined or written once in the test framework 230).

In some embodiments, the namespace component 215 is used to create (also referred to in some aspects as instantiating) and/or manage namespaces 240A-N in accordance with the test framework 230 (e.g., based in part on the annotations identified by the annotation component 210) for execution of the identified test(s). For example, in response to a group namespace annotation, the namespace component 215 may create a single namespace to be used to execute the group of test(s). Similarly, in response to a duplicated namespace annotation, the namespace component 215 may create multiple namespaces (e.g., a set of identical namespaces that are isolated from each other) to allow the test to be executed in each of the duplicated namespaces.

As discussed above, each namespace 240A-N (collectively, namespaces 240) generally corresponds to a virtual container or logical partition of computing resources, where processes and operations in a given namespace 240 may use a shared set of resources within the namespace 240, but cannot see or access resources associated with other namespaces 240. For example, the processes within the namespace 240A may use a shared partition of memory, shared processor access, and the like (such that errors or failures caused by one process in the namespace 240A may impact the other processes in the namespace 240A). However, the processes in the namespace 240A may be unaffected by processes in another namespace 240B (e.g., such that errors or failures caused by processes in the namespace 240B will have no effect on the processes in the namespace 240A).

In some embodiments, the test component 220 executes the relevant error tests in the corresponding namespace(s) 240, as indicated in the test framework 230. For example, as discussed above, in the case of a group namespace annotation, the test component 220 may execute the indicated tests in a single namespace 240 in parallel, injecting any indicated error(s) or fault(s) to determine how the computing environment responds. As another example, in the case of a duplicated namespace annotation, the test component 220 may execute a single test multiple times (e.g., in multiple namespaces 240) in parallel or in sequence, injecting any indicated error(s) appropriately.

In the illustrated example, the result component 225 may evaluate or monitor the execution of the test(s) in the namespace(s) 240 in order to generate a set of test results 235. The particular contents and format of the test results 235 may vary depending on the particular implementation. In some embodiments, the test results 235 indicate, for each test that was initiated by the test framework 230 (e.g., for each namespace 240 and/or for each test that was executed), the results of the test (e.g., whether the test passed or failed, how the system responded to any injected errors, the computational resources consumed during the test and/or in responding to the failure(s), the time or length of the test(s), and the like).

In some aspects, the test results 235 may be output or provided to another entity, such as to the user that provided or initiated the test framework 230. This can allow users to rapidly and efficiently design and execute various tests across any permutation of namespaces 240, significantly improving the accuracy of the testing process (e.g., allowing tests to be performed in a more realistic environment) and reducing the time and expense consumed by such test design and execution. In these ways, the test manager system 205 can ensure the resilience and fault-tolerance of software applications, particularly those designed for complex and distributed systems, to improve the reliability and robustness of such applications.

### Example Workflow for Error Testing in Computing Environments

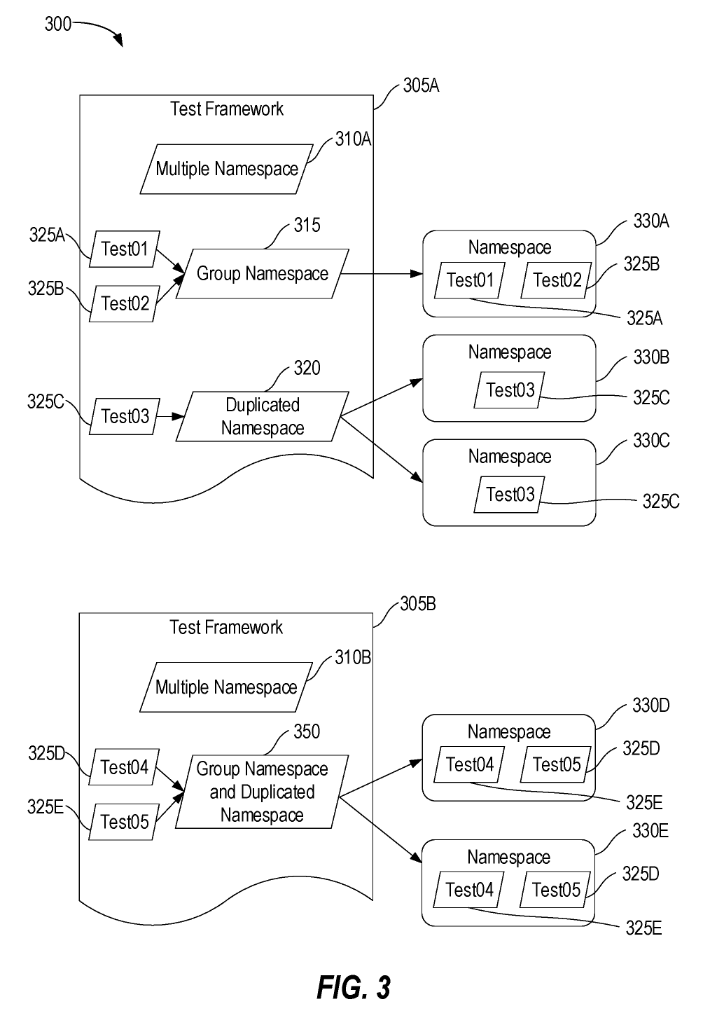

FIG. 3 depicts an example workflow 300 for error testing in computing environments, according to some embodiments of the present disclosure. In some embodiments, the workflow 300 is performed by a testing system, such as the test management code 180 of FIG. 1 and/or the test manager system 205 of FIG. 2.

In the illustrated workflow 300, a test framework 305A (which may correspond to the test framework 230 of FIG. 2) is depicted. As illustrated, the test framework 305A includes a multiple namespace annotation 310A. This multiple namespace annotation 310A may be an optional label depending on the particular implementation, and may be used to indicate that the test framework 305A contains (or may contain) group namespaces and/or duplicated namespaces, as discussed above. In some aspects, the multiple namespace annotation 310A may cause the testing system to execute the test framework 305A using an extended or new testing architecture (rather than a default architecture).

Further, as illustrated, the test framework 305A includes a group namespace annotation 315 and a duplicated namespace annotation 320. In the illustrated example, the group namespace annotation 315 is associated with two tests 325A and 325B (labeled “Test01” and “Test02” in the illustrated example), while the duplicated namespace annotation 320 is associated with a third test 325C (labeled “Test03”). Generally, the association between tests and annotations may be defined using any suitable technique. For example, in the case of the group namespace annotation 315, the test framework 305A may include an instruction to perform the test 325A in a namespace having an identifier of “1,” as well as an instruction to perform the test 325B in a namespace having an identifier of “1” (e.g., to perform both tests 325A and 325B in a single namespace). As another example, in the case of the duplicated namespace annotation 320, the test framework 305A may include an instruction to execute the test 325C in multiple namespaces (potentially with different error injections or other parameters).

Generally, the particular details of a given test 325 may vary depending on the embodiment and implementation. For example, the group namespace annotation 315 may indicate to execute tests such as injecting a network interface failure, emulating a network resource port being occupied, and/or injecting a memory failure all in the same namespace (in parallel or in sequence). As another example, the duplicated namespace annotation 320 may indicate to execute the test 325C in a first namespace with a first injected error, as well as in a second (separate) namespace with a second injected error.

In the illustrated workflow 300, based on the test framework 305A, the testing system creates a first namespace 330A to execute the tests 325A and 325B associated with the group namespace annotation 315, as well as two namespaces 330B and 330C to execute the test 325C associated with the duplicated namespace annotation 320. For example, as discussed above, the testing system may execute the tests 325A and 325B in the namespace 330A in sequence and/or in parallel. Further, the testing system may execute the test 325C in the namespace 330B as well as in the namespace 330C, potentially with different parameters or error injections, separately from each other (e.g., where each instance of the test 325C is performed in isolation, and does not affect other tests in other namespaces 330).

Although the illustrated example depicts a discrete group namespace annotation 315 and a duplicated namespace annotation 320 for conceptual clarity, in some aspects, the test framework 305A may include a combined annotation (referred to in some aspects as a duplicated group namespace annotation) indicating that both the group namespace and the duplicated namespace instructions should be applied. In the illustrated workflow 300, a test framework 305B (which may correspond to the test framework 230 of FIG. 2) is depicted. As illustrated, the test framework 305B includes another multiple namespace annotation 310B. This multiple namespace annotation 310B may be an optional label depending on the particular implementation, and may be used to indicate that the test framework 305B contains (or may contain) group namespaces and/or duplicated namespaces, as discussed above. In some aspects, the multiple namespace annotation 310B may cause the testing system to execute the test framework 305B using an extended or new testing architecture (rather than a default architecture).

Further, as illustrated, the test framework 305B includes a duplicated group namespace annotation 350. In the illustrated example, the duplicated group namespace annotation 350 is associated with two tests 325D and 325E (labeled “Test04” and “Test05” in the illustrated example). Generally, the association between tests and annotations may be defined using any suitable technique, as discussed above. For example, in the case of the duplicated group namespace annotation 350, the test framework 305B may include instructions to perform both of the tests 325D and 325E in multiple namespaces (potentially with different error injections or other parameters).

In the illustrated workflow 300, based on the test framework 305B, the testing system creates two namespaces 330D and 330E, each of which are used to execute both of the tests 325D and 325E associated with the duplicated group namespace annotation 350. For example, as discussed above, the testing system may execute the tests 325D and 325E in the namespace 330D in sequence and/or in parallel. Further, the testing system may execute the tests 325D and 325E (in sequence or in parallel with each other) in the namespace 330E, potentially with different parameters or error injections, separately from the namespace 330D (e.g., where each instance of the tests 325D and 325E are performed in isolation from each other, and do not affect other tests in other namespaces 330). In some aspects, the namespaces 330D and 330E may each be executed in sequence or in parallel with each other.

### Example Method for Multiple Namespace Error Testing in Computing Environments

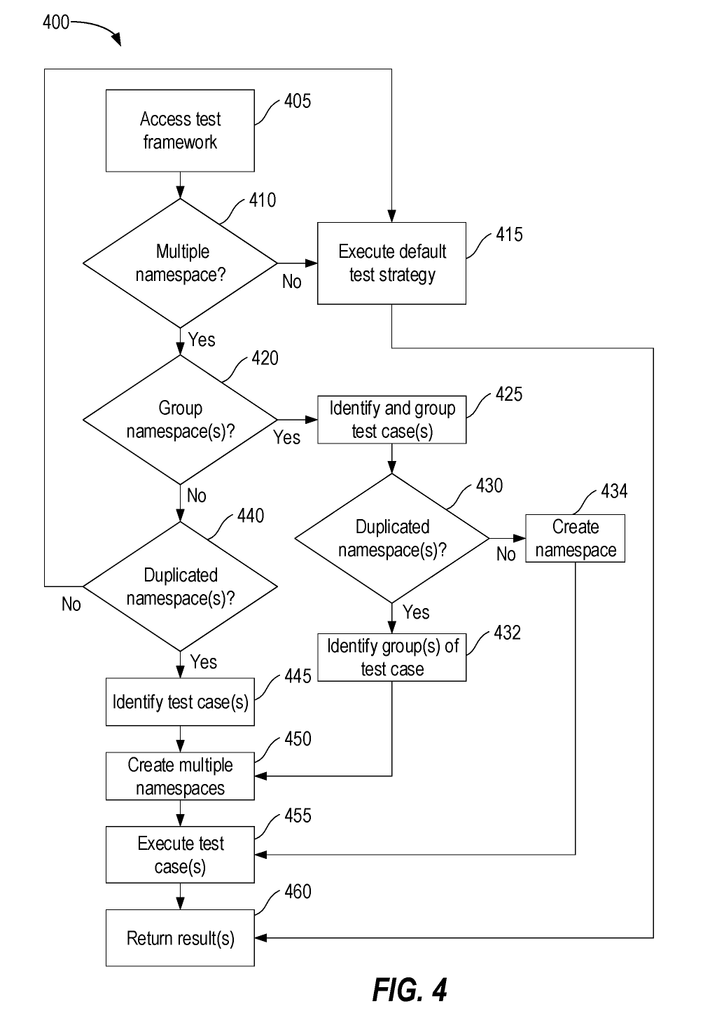

FIG. 4 is a flow diagram depicting an example method 400 for multiple namespace error testing in computing environments, according to some embodiments of the present disclosure. In some embodiments, the method 400 is performed by a testing system, such as the test management code 180 of FIG. 1, the test manager system 205 of FIG. 2, and/or the testing system discussed above with reference to FIG. 3.

At block 405, the testing system accesses a test framework (e.g., the test framework 230 of FIG. 2 and/or the test framework 305A and/or 305B of FIG. 3). In some aspects, as discussed above, the testing system can receive the test framework from a user or other system. Generally, the test framework indicates the test(s) to be performed in the computing environment, as well as particular configurations and parameters to use during testing (e.g., how the tests are distributed among namespaces, what errors are to be injected, and the like).

At block 410, the testing system determines whether the test framework includes a multiple namespace annotation (e.g., the multiple namespace annotation 310A and/or 310B of FIG. 3). If not, the method 400 continues to block 415, where the testing system executes the test framework in accordance with a default testing strategy (e.g., creating a namespace for each test indicated in the test framework, and executing each test in its own isolated namespace).

Returning to block 410, if the testing system determines that the test framework includes at least one multiple namespace annotation, the method 400 continues to block 420, where the testing system determines whether the test framework includes at least one group namespace annotation (e.g., the group namespace annotation 315 of FIG. 3). If not, the method 400 continues to block 440, discussed in more detail below.

If the test framework includes at least one group namespace annotation, the method 400 continues to block 425. At block 425, the testing system identifies the test case(s) (e.g., tests 325 of FIG. 3) associated with or linked to the group namespace annotation (or to each group namespace annotation). That is, the testing system may identify the set(s) of test cases that are to be executed in the shared namespace(s).

At block 430, the testing system determines whether any of the group namespace(s) are also associated with a duplicated namespace annotation (e.g., whether any duplicated group namespace annotations are included), as discussed above. That is, the testing system may determine whether any of the grouped test cases should also be duplicated across multiple namespaces, as discussed above. If so, the method 400 continues to block 432, where the testing system identifies the group(s) of test cases (defined by group annotations) that should also be executed in duplicated namespace(s). The method 400 then continues to block 450, discussed in more detail below. Returning to block 430, if the testing system determines that the group annotation(s) do not include duplicated namespace instructions, the method 400 continues to block 434. At block 434, the testing system creates or instantiates a namespace for the group test (e.g., a respective namespace for each respective group of test cases). The method 400 then continues to block 455, discussed in more detail below. In some aspects, blocks 425, 430, and 432 and/or 434 may be repeated for each group namespace annotation in the test framework (in sequence or in parallel).

Returning to block 420, if the testing system determines that the test framework does not include any group namespace annotations, the method 400 continues to block 440. At block 440, the testing system determines whether the test framework includes one or mode duplicated namespace annotations (e.g., the duplicated namespace annotation 320 of FIG. 3). If not, the method 400 continues to block 415 (to execute the default testing framework or strategy). If the test framework includes at least one duplicated namespace annotation, the method 400 continues to block 445.

At block 445, the testing system identifies the test case(s) (e.g., tests 325 of FIG. 3) associated with or linked to the duplicated namespace annotation. That is, the testing system may identify the set of test cases that are to be executed in a set of duplicated namespace(s). At block 450, the testing system then creates or instantiates multiple namespaces for the test case(s) that are to be duplicated (determined at block 445 and/or 432), as discussed above. For example, the testing system may create a number of namespaces based on the desired number indicated in the test framework, based on the number of different error injections or other parameters that are specified for the duplicated namespace annotation, and the like.

At block 455, the testing system executes or performs the identified test case(s) in each of the created namespaces (e.g., in parallel). The method 400 then continues to block 460. In some aspects, blocks 445, 450, and 455 may be repeated for each duplicated namespace annotation in the test framework (in sequence or in parallel). Although the illustrated example depicts executing the group namespace annotation(s) prior to executing the duplicated namespace annotation(s), it is to be understood that the testing system may generally process the annotations and test cases in any order, including entirely in sequence, as well as partially or entirely in parallel.

At block 460, the testing system returns the result(s) of the execution of the test case(s) in the namespace(s), as discussed above. For example, the testing system may determine a first set of test results with respect to the group namespace(s), as well as a second set of test results with respect to each duplicated namespace. As discussed above, these test results may generally indicate any results of the test execution, such as the errors encountered, computational resources used, time consumed to execute the test, and the like.

As discussed above, this can allow the various tests to be rapidly and efficiently designed and executed across any permutation of namespaces, significantly improving the accuracy of the testing process (e.g., allowing tests to be performed in a more realistic environment) and reducing the time and expense consumed by such test design and execution. In these ways, the testing system can ensure the resilience and fault-tolerance of software applications, particularly those designed for complex and distributed systems, to improve the reliability and robustness of such applications. In some embodiments, the test results can be evaluated by a user in order to identify and enact various corrective or preventative actions. In some embodiments, some or all of the test results can be automatically reviewed to enable automated corrective or preventative remediation actions (e.g., the system itself may identify errors, such as memory overflows, that occurred during a test, and may determine to allocate more memory to the affected process(es) in the future).

### Example Method for Improved Error Testing

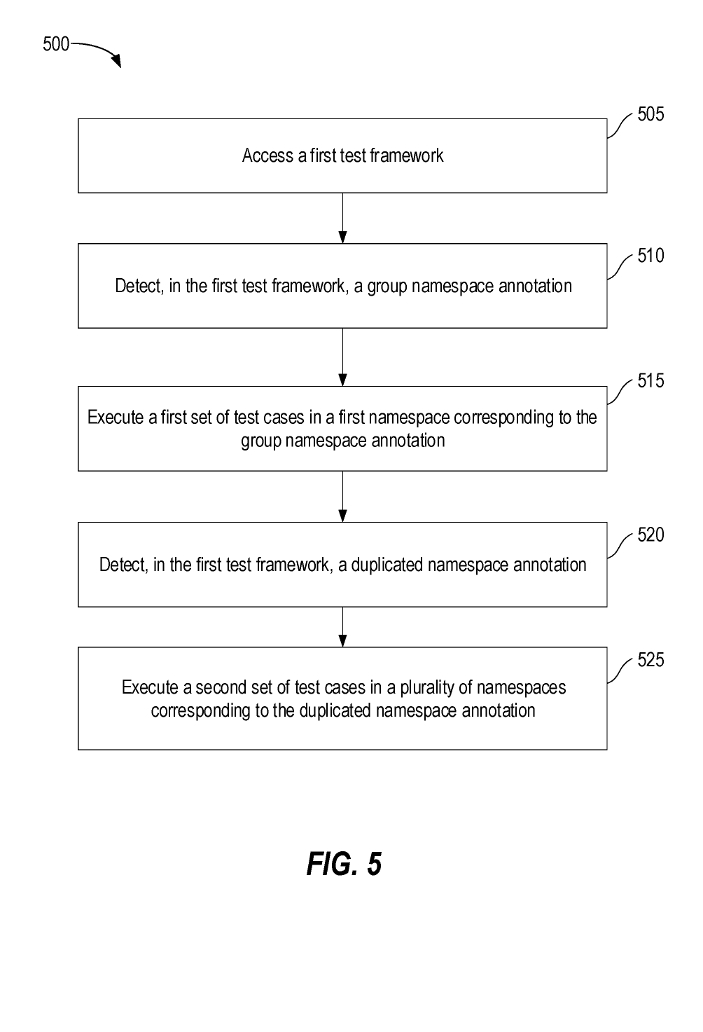

FIG. 5 is a flow diagram depicting an example method 500 for improved error testing, according to some embodiments of the present disclosure. In some embodiments, the method 500 is performed by a testing system, such as the test management code 180 of FIG. 1, the test manager system 205 of FIG. 2, and/or the testing system discussed above with reference to FIGS. 3 and/or 4.

At block 505, a first test framework (e.g., the test framework 230 of FIG. 2 and/or the test framework 305A and/or 305B of FIG. 3) is accessed. In some aspects, the first test framework includes a multiple namespace annotation (e.g., the multiple namespace annotation 310A and/or 310B of FIG. 3).

At block 510, a group namespace annotation (e.g., the group namespace annotation 315 of FIG. 3) is detected in the first test framework.

At block 515, a first set of test cases (e.g., the tests 325A and 325B of FIG. 3) is executed in a first namespace (e.g., a namespace 240 of FIG. 2 and/or the namespace 330A of FIG. 3) corresponding to the group namespace annotation.

At block 520, a duplicated namespace annotation (e.g., the duplicated namespace annotation 320 of FIG. 3) is detected in the first test framework.

At block 525, a second set of test cases (e.g., the test 325C of FIG. 3) is executed in a plurality of namespaces (e.g., the namespaces 240 of FIG. 2 and/or the namespaces 330B and 330C of FIG. 3) corresponding to the duplicated namespace annotation.

While the foregoing is directed to embodiments of the present invention, other and further embodiments of the invention may be devised without departing from the basic scope thereof, and the scope thereof is determined by the claims that follow.

What is claimed is:

1. A method, comprising:
accessing a first test framework;
detecting, in the first test framework, a group namespace annotation;
executing a first set of test cases in a first namespace corresponding to the group namespace annotation;
detecting, in the first test framework, a duplicated namespace annotation; and
executing a second set of test cases in a plurality of namespaces corresponding to the duplicated namespace annotation.

2. The method of claim 1, further comprising, in response to detecting the group namespace annotation:
identifying the first set of test cases in the first test framework corresponding to the group namespace annotation; and
creating the first namespace based on the group namespace annotation.

3. The method of claim 1, further comprising, in response to detecting the duplicated namespace annotation:
identifying the second set of test cases in the first test framework corresponding to the duplicated namespace annotation; and
creating the plurality of namespaces based on the duplicated namespace annotation.

4. The method of claim 1, wherein executing the first set of test cases comprises executing a plurality of test cases in the first namespace.

5. The method of claim 1, wherein executing the second set of test cases comprises executing each test case of the second set of test cases in each of the plurality of namespaces.

6. The method of claim 1, further comprising:
receiving a first set of test results with respect to the first namespace; and
receiving a second set of test results with respect to the plurality of namespaces.

7. The method of claim 1, further comprising:
detecting, in the first test framework, a duplicated group namespace annotation; and
executing a third set of test cases in a second plurality of namespaces corresponding to the duplicated group namespace annotation.

8. The method of claim 1, further comprising:
accessing a second test framework; and
in response to detecting that the second test framework does not include a multiple namespace annotation, executing a test case in a namespace according to the second test framework.

9. A system comprising:
one or more memories collectively storing computer-executable instructions; and
one or more processors configured to collectively execute the computer-executable instructions and cause the system to perform an operation comprising:
accessing a first test framework;
detecting, in the first test framework, a group namespace annotation;
executing a first set of test cases in a first namespace corresponding to the group namespace annotation;
detecting, in the first test framework, a duplicated namespace annotation; and
executing a second set of test cases in a plurality of namespaces corresponding to the duplicated namespace annotation.

10. The system of claim 9, the operation further comprising, in response to detecting the group namespace annotation:
identifying the first set of test cases in the first test framework corresponding to the group namespace annotation; and
creating the first namespace based on the group namespace annotation.

11. The system of claim 9, the operation further comprising, in response to detecting the duplicated namespace annotation:
identifying the second set of test cases in the first test framework corresponding to the duplicated namespace annotation; and
creating the plurality of namespaces based on the duplicated namespace annotation.

12. The system of claim 9, wherein executing the first set of test cases comprises executing a plurality of test cases in the first namespace.

13. The system of claim 9, wherein executing the second set of test cases comprises executing each test case of the second set of test cases in each of the plurality of namespaces.

14. The system of claim 9, the operation further comprising:
receiving a first set of test results with respect to the first namespace; and
receiving a second set of test results with respect to the plurality of namespaces.

15. The system of claim 9, the operation further comprising:
detecting, in the first test framework, a duplicated group namespace annotation; and
executing a third set of test cases in a second plurality of namespaces corresponding to the duplicated group namespace annotation.

16. A computer program product, comprising a computer-readable storage medium having computer-readable program code executable to cause the computer program product to perform an operation comprising:
accessing a first test framework;
detecting, in the first test framework, a group namespace annotation;
executing a first set of test cases in a first namespace corresponding to the group namespace annotation;
detecting, in the first test framework, a duplicated namespace annotation; and
executing a second set of test cases in a plurality of namespaces corresponding to the duplicated namespace annotation.

17. The computer program product of claim 16, the operation further comprising, in response to detecting the group namespace annotation:
identifying the first set of test cases in the first test framework corresponding to the group namespace annotation; and
creating the first namespace based on the group namespace annotation.

18. The computer program product of claim 16, the operation further comprising, in response to detecting the duplicated namespace annotation:
identifying the second set of test cases in the first test framework corresponding to the duplicated namespace annotation; and
creating the plurality of namespaces based on the duplicated namespace annotation.

19. The computer program product of claim 16, wherein executing the first set of test cases comprises executing a plurality of test cases in the first namespace.

20. The computer program product of claim 16, wherein executing the second set of test cases comprises executing each test case of the second set of test cases in each of the plurality of namespaces.
